(19) United States
(12) Patent Application Publication
(10) Pub. No.: US 2010/0322722 A1
(43) Pub. Date: Dec. 23, 2010

(54) Combined-Type Lathe Tool

(75) Inventor: Kuo-Chi Lin, Taiwan (CN)

Correspondence Address: Dr. BANGER SHIA;Patent Office of Bang Shia, 102 Lindencrest Ct, Sugar Land, TX, 77479-5201, US

(73) Assignee: YING-FAN ENTERPRISE CO., LTD., Taichung City (TW)

(21) Appl. No.: 12/865,552

(22) PCT Filed: Jun. 13, 2008
(86) PCT No.: PCT/CN2008/071285

§ 371 Date: Jul. 30, 2010

(30) Foreign Application Priority Data
Feb. 4, 2008 (CN) 200820006230.9

(51) Int. Cl. B23B 27/10; B23B 29/12

(52) U.S. Cl. 407/11; 407/101

(57) ABSTRACT

A combinative cutter includes a holder, a shank, a blade and at least two screws. The holder includes an eccentric bore defined at an end and at least two screw holes in communication with the eccentric bore. The shank is inserted in the eccentric bore and formed with a planar face. The blade is attached to an end of the shank extending beyond the holder. The screws are driven through the screw holes and abutted against the planar face to keep the shank in the eccentric bore.

### BACKGROUND OF INVENTION

1. FIELD OF INVENTION

The present invention relates to a cutter of a large machine tool and, more particularly, to a combinative cutter.

2. RELATED PRIOR ART

Large components are needed in some fields. Such large components can be molded. For precision in size, such large components can further be processed with large machine tools such as gantry millers, gantry lathes and gantry grinders. The workloads on such large machine tools are heavy, and the power fed to these large machine tools is high. Conventional small cutters cannot stand vibration in the operation of such large machine tools. Should such a small cutter be used in such a large machine tool, not only the life of the small cutter would be shortened, but also the efficiency and precision of the operation would be affected.

Conventionally, such large machine tools are equipped with specialized cutters. Referring to FIG. 5, there is shown a cutter of a large lathe for example. The cutter includes a shank 50, an eccentric block 55 extending from an end of the shank 50, and a blade 56 secured to the eccentric block 55. The shank 50 includes a planar face 51 with which the shank 50 can be locked to a holder of the machine tool. Thus, the blade 56 can be moved toward a workpiece. The shank 50 is large and hence is stable in the operation for increasing the efficiency and precision of the operation.

A problem with the shank 50 is difficulty in positioning and moving the shank 50 because it is bulky and heavy. This causes troubles in the operation and affects the efficiency and safety of the operation. Moreover, the shank 50 is expensive for consuming a lot of material of which the price is skyrocketing.

Furthermore, cutting liquid must be used to cool a conventional cutter and wash away debris from a workpiece in operation. To replace the blade 56 with a new one, the shank 50 has to been replaced with a new one. It is difficult to align a jet of the cutting liquid to the new blade 56, thus jeopardizing the effects of the cooling and washing. Hence, the blade 56 becomes obtuse or broken because of heat, and the life thereof is shortened.

The present invention is therefore intended to obviate or at least alleviate the problems encountered in prior art.

### SUMMARY OF INVENTION

It is an objective of the present invention to provide an inexpensive combinative cutter that is stable yet convenient in operation.

It is another objective of the present invention to provide an enduring combinative cutter that can be adjusted easily and with which cutting liquid can precisely be fed to a place where cutting occurs to avoid the combinative cutter from becoming obtuse or broken too increase the efficiency and precision of the cutting.

To achieve the foregoing objectives, the combinative cutter includes a combinative cutter includes a holder, a shank, a blade and at least two screws. The holder includes an eccentric bore defined at an end and at least two transverse screw holes in communication with the eccentric bore. The shank is inserted in the eccentric bore and formed with a planar face. The blade is attached to an end of the shank extending beyond the holder. The screws are driven in the transverse screw holes and abutted against the planar face to keep the shank in the eccentric bore.

The holder includes two opposite planar faces for firm contact with corresponding planar faces of a mount.

Each of the screws is driven through a washer.

The blade is attached to the shank by welding or in a detachable manner.

The holder includes a channel defined therein for piping cutting liquid, a spherical recess in communication with the channel, and a first longitudinal screw hole overlapping the spherical recess. A nozzle is located in the spherical recess. A screw is driven in the first longitudinal screw hole to keep the nozzle in the spherical recess.

The holder includes an aperture through which the cutting liquid can go into the channel. The channel includes a second longitudinal screw hole. A non-return screw is driven in the second longitudinal screw hole.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a combinative cutter according to the preferred embodiment of the present invention;

FIG. 2 is a perspective view of the combinative cutter shown in FIG. 1;

FIG. 3 is a cross-sectional view of the combinative cutter shown in FIG. 1;

FIG. 4 is a perspective view of the combinative cutter shown in FIG. 1 in operation; and

FIG. 5 is a perspective view of a conventional cutter.

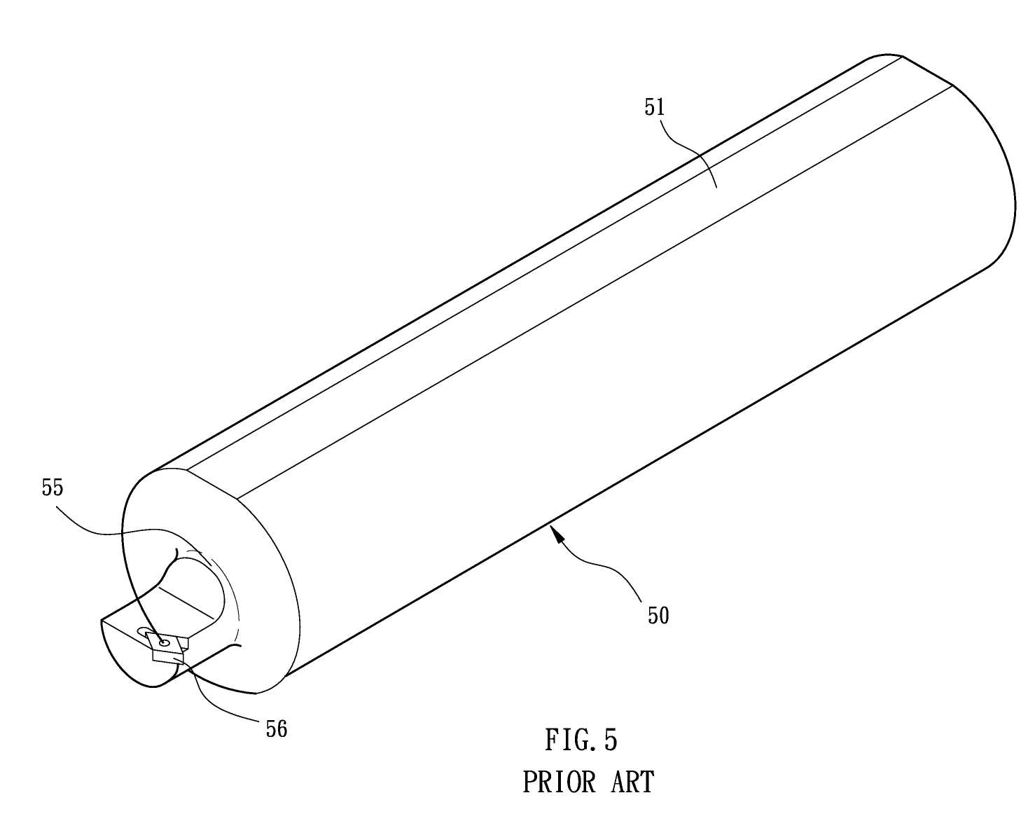

### DETAILED DESCRIPTION OF PREFERRED EMBODIMENT

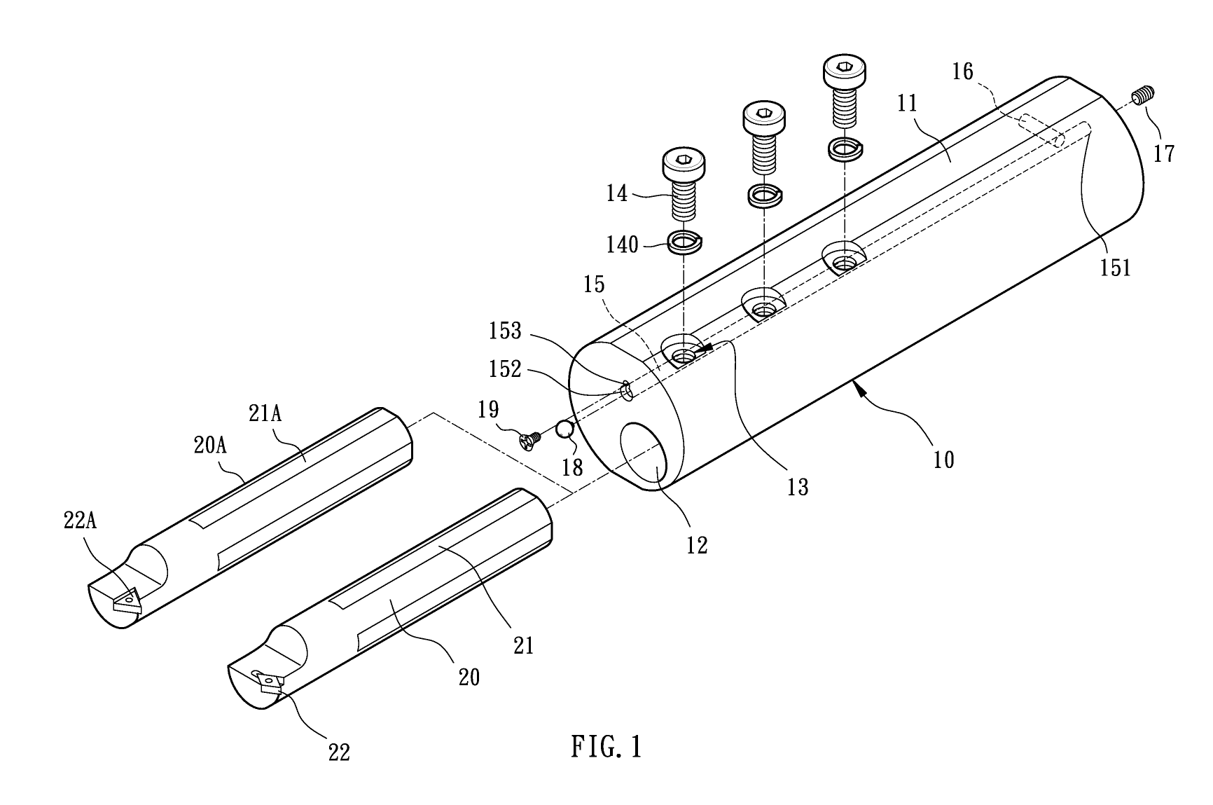

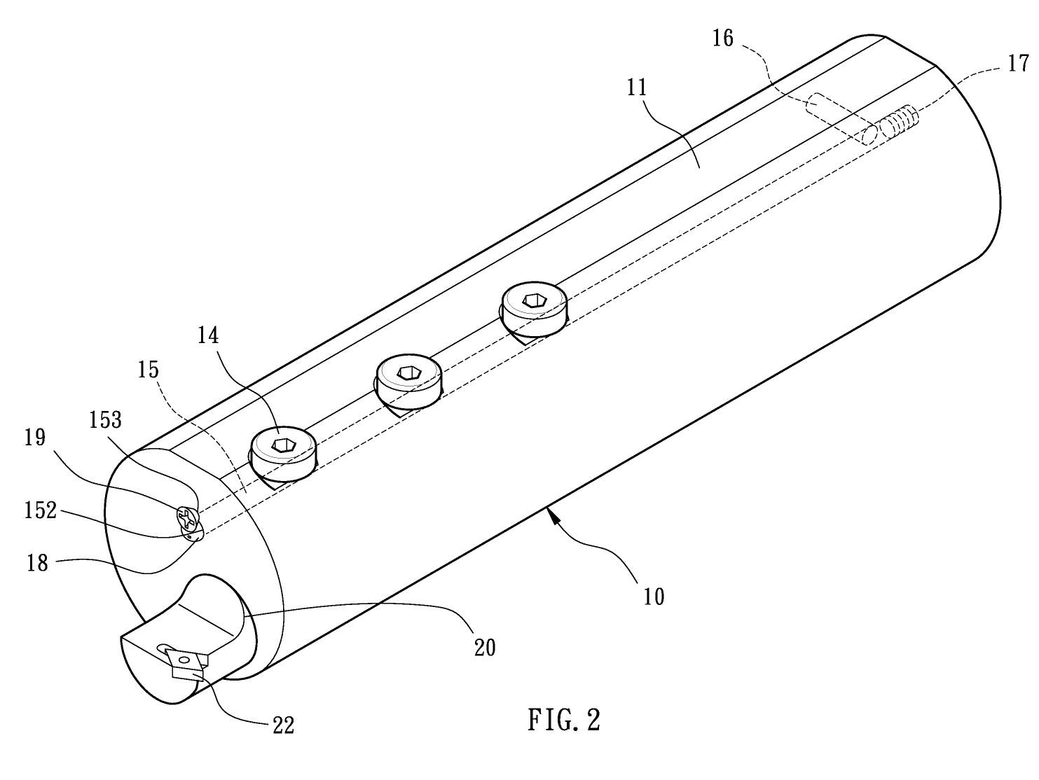

Referring to FIGS. 1 and 2, a combinative cutter includes a holder 10 and a shank 20 according to the preferred embodiment of the present invention. The shank 20 is located on the holder 10 eccentrically. The blade 22 is secured to the shank 20.

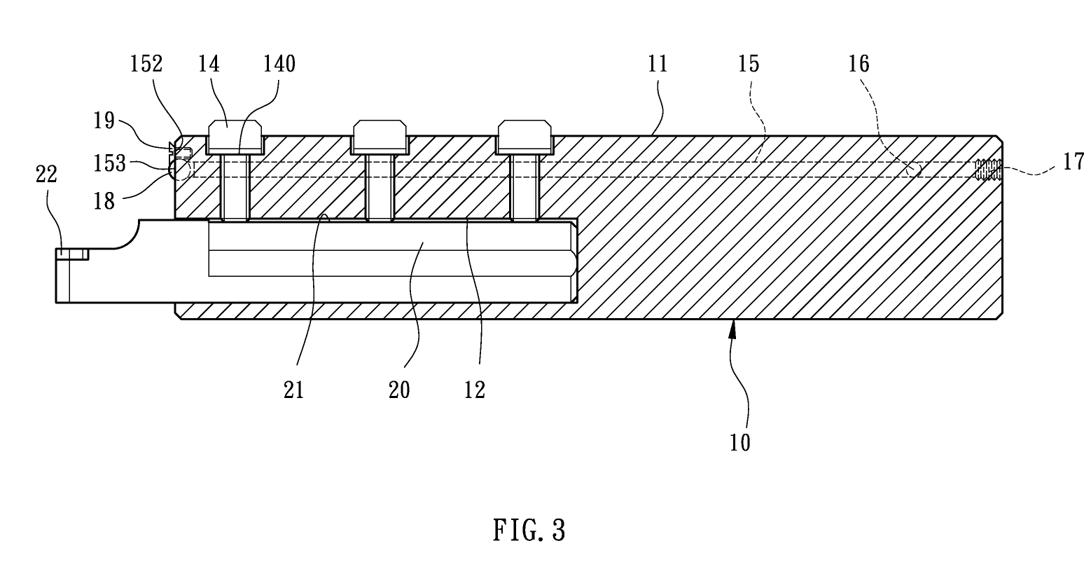

Referring to FIGS. 1 through 3, the holder 10 is cylindrical. The holder 10 includes, on the periphery, at least one planar face 11 with which the holder 10 can be located on a mount stably. An eccentric bore 12 is defined in an eccentric position at an end of the holder 10. Two screw holes 13 or more are defined in the periphery of the holder 10. The screw holes 13 are in communication with the eccentric bore 12. Thus, screws 14 can be driven in the eccentric bore 12 through the screw holes 13. Each of the screws 14 is inserted through a washer 140 to prevent accidental slacking thereof. The holder 10 includes a channel 15 defined therein. The holder 10 includes an aperture 16 defined therein opposite to the eccentric bore 12. The aperture 16 is in communication with channel 15. The aperture 16 can receive a tube for piping cutting liquid. The channel 15 includes a screw hole 151 near an end opposite to the eccentric bore 12. A non-return screw 17 can be driven in the screw hole 151. The holder 10 includes a spherical recess 152 defined at the end at which the eccentric bore 12 is defined. The spherical recess 152 is in communication of fluid with the channel 15. Another screw hole 153 is defined in the holder 10. The screw hole 153 and the spherical recess 152 overlap. Another screw 19 is driven in the screw hole 153 to keep a spherical nozzle 18 in the spherical recess 152. Thus, the cutting liquid can be sent through the aperture 16 and the channel 15 sprayed from the nozzle 18. The position of the spherical nozzle 18 can be adjusted because of the spherical nozzle 18 and the spherical recess 152.

The shank 20 can be inserted in the eccentric bore 12 of the holder 10. The shank 20 includes a planar face 21 extending on the periphery. The screws 14 can be abutted against the planar face 21 to lock the shank 20 in the eccentric bore 12. A blade 22 is located at end of the shank 20 that extends beyond the holder 10. The blade 22 may be attached to the end of the shank 20 by welding or in a detachable manner. As discussed above, the stable and inexpensive combinative cutter is made.

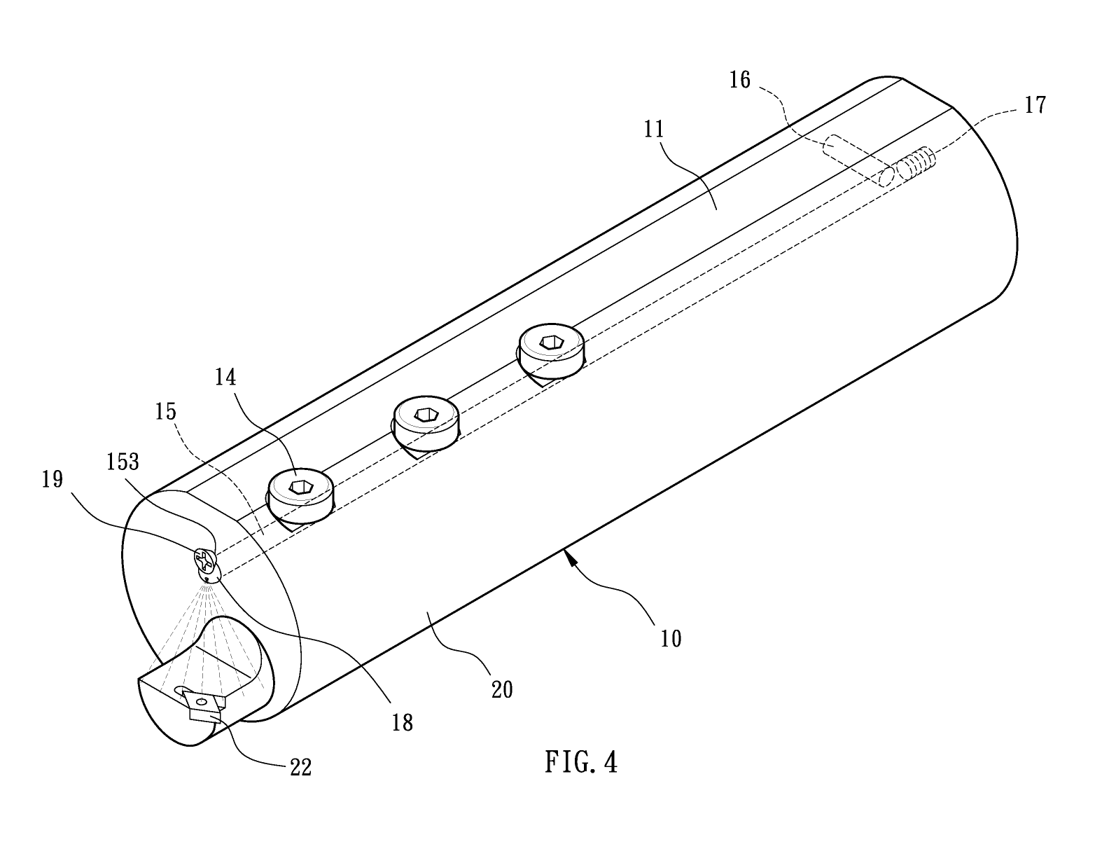

Referring to FIG. 4, the blade 22 or 22A attached to the shank 20 or 20A is inserted in the eccentric bore 12 of the holder 10. The screws 14 are driven in the screw holes 13 and abutted against the planar 21 or 21A. Thus, the shank 20 or 20A is retained on the holder 10. Hence, a holder 10 can be used to hold various shanks 20 and 20A. Thus, the entire volume is reduced, and convenience in the operation is increased since only the shank 20 or 20A is replaced with a new one.

Moreover, the cost of the production and use of the cutter are low because only the shank 20 or 20A is replaced with a new one. The operation is stable because the shank 20 or 20A is inserted in the holder 10.

Furthermore, the spherical nozzle 18 is located in the holder 10. Only the position of the nozzle 18 relative to the blade 22 attached to the shank 20 has to be adjusted to align a jet of cutting liquid to the blade 22 to extend the life by reducing risks of becoming obtuse or broken. Hence, the economic benefits are high.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A combinative cutter including:
a holder including an eccentric bore defined at an end and at least two transverse screw holes in communication with the eccentric bore;
a shank inserted in the eccentric bore and formed with a planar face;
a blade attached to an end of the shank extending beyond the holder, and
at least two screws driven in the transverse screw holes and abutted against the planar face to keep the shank in the eccentric bore.

2. The combinative cutter according to claim 1, wherein the holder includes two opposite planar faces for firm contact with corresponding planar faces of a mount.

3. The combinative cutter according to claim 1, wherein each of the screws is driven through a washer.

4. The combinative cutter according to claim 1, wherein the blade is attached to the shank by welding or in a detachable manner.

5. The combinative cutter according to claim 1, wherein the holder includes a channel defined therein for piping cutting liquid, a spherical recess in communication with the channel, and a longitudinal screw hole overlapping the spherical recess, wherein the combinative cutter includes a nozzle located in the spherical recess and a screw driven in the longitudinal screw hole of the holder 10 to keep the nozzle in the spherical recess.

6. The combinative cutter according to claim 1, wherein the holder includes an aperture through which cutting liquid can travel into the channel and a longitudinal screw hole in communication with an end of the channel,
wherein the combinative cutter includes a non-return screw driven in the longitudinal screw hole.
